(19) United States
(12) Patent Application Publication
(10) Pub. No.: US 2022/0229424 A1
(43) Pub. Date: Jul. 21, 2022

(54) Systems and Methods for Analyzing Manufacturing Runs

(71) Applicant: Oden Technologies Ltd., London (GB)

(72) Inventors: Matthew Henry LINDER, Boston, MA (US); Devon PETICOLAS, Brooklyn, NY (US); Willem SUNDBLAD, Pawlet, VT (US); Deepak S. TURAGA, New City, NY (US); Jeswanth YADAGANI, New York, NY (US)

(21) Appl. No.: 17/558,931

(22) Filed: Dec. 22, 2021

Related U.S. Application Data
(60) Provisional application No. 63/129,880, filed on Dec. 23, 2020.

(51) Int. Cl. G05B 19/418

(52) U.S. Cl. CPC G05B 19/41865; G05B 19/4188; G05B 19/41885

(57) ABSTRACT

The present disclosure provides systems and methods for analyzing runs. In an aspect, the present disclosure provides a method for extracting semantic artifacts from manufacturing data. The method may comprise: (a) receiving manufacturing data corresponding to a manufacturing process, wherein the manufacturing data comprises at least one of observation data, context data, temporal metric data, and/or overall equipment effectiveness (OEE) components associated with the manufacturing process; (b) extracting one or more semantic artifacts from the manufacturing data; and (c) using the one or more semantic artifacts to generate a summary representation of the manufacturing process.

### CROSS REFERENCE

This application claims priority to U.S. Provisional Patent Application No. 63/129,880 filed on Dec. 23, 2020, which application is incorporated herein by reference in its entirety for all purposes.

### BACKGROUND

Manufacturing processes may be used to fabricate various physical goods for a multitude of different end users or industrial applications. Such manufacturing processes can be adjusted or modified to achieve a desired output. Adjusting or modifying manufacturing processes can involve different optimizations based on the type of manufacturing process, the type of manufacturing systems used to implement the manufacturing process, and/or the type of goods fabricated using the manufacturing process.

### SUMMARY

The present application relates generally to data processing systems and methods, and more particularly, to systems and methods for analyzing and optimizing manufacturing processes.

In one aspect, the present disclosure provides a method for analyzing manufacturing runs. A manufacturing run (also called a production run, or an assembly run) may comprise or may be defined by a contiguous period in time, having a well-defined start time and end time, during which one or more manufacturing processes can be used to produce one or more types of products until desired metrics (e.g., inventory levels) are reached. The method may comprise (a) receiving manufacturing data corresponding to a manufacturing process, wherein the manufacturing data comprises at least one of observation data, context data, temporal metric data, and/or overall equipment effectiveness (OEE) components associated with the manufacturing process; (b) extracting one or more semantic artifacts from the manufacturing data; and (c) using the one or more semantic artifacts to generate a summary representation of the manufacturing process and various aspects thereof (e.g., performance, efficiency, etc.).

In some embodiments, the manufacturing data may comprise data about the manufacturing process that is obtained using one or more sensors and/or from one or more data sources. The manufacturing data may include any type or form of data or metadata as described elsewhere herein. For example, the manufacturing data may include process data and/or metadata such as, for example, Observation Data, Context Data, Metric Data, and/or OEE Data.

In some embodiments, the context data may comprise (i) data represented as intervals with a start timestamp and an end timestamp and (ii) a value that describes or quantifies an aspect of an execution of the manufacturing process, wherein such value is associated with one or more operators, shifts, materials, products, batches, phases, and/or states relating to the manufacturing process. In some embodiments, the context data may comprise data corresponding to one or more time intervals, wherein the data comprises one or more values quantifying or representing a characteristic, quality, parameter, or property of (i) the manufacturing process or an execution thereof or (ii) an output of the manufacturing process.

In some embodiments, the temporal metric data may comprise data represented as a numerical timeseries that measures one or more mechanical, physical, chemical, and/or operational properties of the manufacturing process.

In some embodiments, the OEE components may comprise data about a product quality, a manufacturing performance, and/or a manufacturing availability associated with an operation or an execution of one or more steps of the manufacturing process.

In some embodiments, the one or more semantic artifacts may correspond to a ramp-up, a stable period, an unstable period, and/or a downtime associated with the manufacturing process. In some embodiments, the one or more semantic artifacts may comprise a name, a category, and/or one or more start timestamps or end timestamps.

In some embodiments, the summary representation of the manufacturing process may comprise a feature representation comprising the context data, one or more start timestamps and/or one or more end timestamps associated with the manufacturing process or a portion thereof, a fixed-bin temporal summary of one or more process metrics, a fixed-num temporal summary of the one or more process metrics, and optionally one or more OEE components associated with the manufacturing process.

In some embodiments, the method may further comprise generating the fixed-bin feature representation by partitioning a duration of the manufacturing process into one or more fixed-width sub-intervals controlled by a resolution parameter, and computing moments, trends, and/or extrema of the metric data for each sub-interval.

In some embodiments, the method may further comprise generating the fixed-num representation by partitioning the manufacturing process into a fixed number of sub-intervals having an equal width, wherein the width is determined by dividing a time duration of the manufacturing process by a number parameter, and computing moments, trends, and extrema of the metric data for each sub-interval.

In some embodiments, the method may further comprise converting the fixed-num feature summary into an image and applying one or more image analysis techniques to extract the one or more semantic artifacts or any metadata associated with the one or more semantic artifacts.

In some embodiments, the method may further comprise training a live machine learning model for each type of semantic artifact and a category associated with the semantic artifact to classify one or more feature vectors, which feature vectors are extracted from at least one sub-interval of a fixed-bin temporal summary associated with the manufacturing process and one or more context intervals for the manufacturing process.

In some embodiments, the method may further comprise training an offline machine learning model for each type of semantic artifact and a category associated with the semantic artifact to classify one or more feature vectors, which feature vectors are extracted from at least one sub-interval of a fixed-num temporal summary associated with the manufacturing process, one or more context intervals for the manufacturing process, and the one or more OEE components for the manufacturing process. In some embodiments, the method may further comprise applying the trained live model for each artifact and category in real-time to infer the one or more artifacts and their categories for one or more fixed-bin sub-intervals of an ongoing run. In some embodiments, the method may further comprise applying the trained offline model for each artifact and category after a run is completed to infer the one or more artifacts and their categories for one or more fixed-num sub-intervals of the completed run.

In some embodiments, the method may further comprise applying smoothing (e.g., temporal smoothing) to one or more outputs of the trained models to ensure that the one or more inferred artifacts are contiguous in time. In some embodiments, the method may further comprise using the one or more inferred artifacts to construct or update the summary representation of the manufacturing process.

Another aspect of the present disclosure provides a non-transitory computer readable medium comprising machine executable code that, upon execution by one or more computer processors, implements any of the methods above or elsewhere herein.

Another aspect of the present disclosure provides a system comprising one or more computer processors and computer memory coupled thereto. The computer memory comprises machine executable code that, upon execution by the one or more computer processors, implements any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 schematically illustrates a system for analyzing a run, in accordance with some embodiments.

FIG. 2 schematically illustrates observed data, context, and results for a given run, in accordance with some embodiments.

FIG. 3 schematically illustrates inferred semantic artifacts from a given run, in accordance with some embodiments.

FIG. 4A schematically illustrates partitioning a run into fixed-bin and fixed-num summaries, in accordance with some embodiments.

FIG. 4B schematically illustrates converting fixed-num representations to images, in accordance with some embodiments.

FIG. 5 schematically illustrates training an uptime model from the fixed-bin feature representation, in accordance with some embodiments.

FIG. 6 schematically illustrates inferring the artifact label using a live binary model, in accordance with some embodiments.

FIG. 7 schematically illustrates temporal smoothing of an inferred artifact label, in accordance with some embodiments.

FIG. 8 schematically illustrates a computer system that is programmed or otherwise configured to implement methods provided herein.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

The term “real time” or “real-time,” as used interchangeably herein, generally refers to an event (e.g., an operation, a process, a method, a technique, a computation, a calculation, an analysis, a visualization, an optimization, etc.) that is performed using recently obtained (e.g., collected or received) data. In some cases, a real time event may be performed almost immediately or within a short enough time span, such as within at least 0.0001 millisecond (ms), 0.0005 ms, 0.001 ms, 0.005 ms, 0.01 ms, 0.05 ms, 0.1 ms, 0.5 ms, 1 ms, 5 ms, 0.01 seconds, 0.05 seconds, 0.1 seconds, 0.5 seconds, 1 second, or more. In some cases, a real time event may be performed almost immediately or within a short enough time span, such as within at most 1 second, 0.5 seconds, 0.1 seconds, 0.05 seconds, 0.01 seconds, 5 ms, 1 ms, 0.5 ms, 0.1 ms, 0.05 ms, 0.01 ms, 0.005 ms, 0.001 ms, 0.0005 ms, 0.0001 ms, or less.

### Overview

Data may be used to improve manufacturing. Recently, the computerization of manufacturing has resulted in broad and rapid changes in the ways that data can be collected and processed, as well as the sheer volume of data available. The systems and methods of the present disclosure may be implemented to help manufacturers leverage manufacturing data in all forms and types to quickly identify process trends and even warning signs of machine breakdown or sub-optimal machine operation/performance. Such visibility can reveal opportunities to improve manufacturing and maintenance processes that reduce waste and increase profit margins.

The systems and methods of the present disclosure may provide numerous benefits and advantages from a manufacturing standpoint. For example, the systems and methods of the present disclosure may be implemented to increase first-pass yield with recommended process parameters that maximize throughput without compromising quality. The systems and methods of the present disclosure may also improve labor effectiveness by giving manufacturing teams the tools needed to monitor, analyze and optimize production. Material waste may also be reduced by minimizing variability in production processes to promote or enhance material usage efficiency. In some cases, the systems and methods of the present disclosure may be used to maximize profitability by eliminating waste and other inefficiencies to increase overall contribution margins. In some cases, the systems and methods of the present disclosure may help to prevent quality failures with real-time alerts that enable operators to proactively adjust process parameters to increase first-pass yield and maintain compliance. In some cases, the systems and methods of the present disclosure may be implemented to optimize material usage by predicting scrap rates based on live production conditions and alert supervisors if desired rates are about to be exceeded. In some cases, the systems and methods of the present disclosure may be used to quickly isolate defects by identifying when and where in the production process defects occur or have occurred to limit the overall number of pieces scrapped. Further, the systems and methods of the present disclosure may help to increase contribution margins by minimizing scrap, reducing production variability to limit material waste, and improving labor effectiveness. In some embodiments, the systems and methods of the present disclosure may be implemented to avoid overproduction by consistently attaining or exceeding yield targets and quickly identifying high scrap rates to reduce the amount of time spent producing defects. In other embodiments, the systems and methods of the present disclosure may be used to help track common downtime causes associated with process variables to drive advanced analysis into the root causes behind unplanned downtime scenarios. In some cases, the systems and methods of the present disclosure may be used to optimize changeover processes and enable swift product changeovers to adapt to changes in demand and empower a just-in-time manufacturing strategy. In other cases, the systems and methods of the present disclosure may be used to analyze machine or manufacturing equipment conditions (e.g., temperature, vibration or line speed, total operational time) that typically contribute to machine jams or other causes of downtime, and to monitor sensitive machine components such as pumps, motors, belts and fans for abnormal behaviors that can indicate a potential failure.

Systems and Methods for Analyzing Runs

In an aspect, the present disclosure provides systems and methods for analyzing runs. As used herein, a run may refer to a manufacturing run, a production run, an assembly run, a fabrication run, and/or any industrial process comprising one or more steps that may be executed in series and/or in parallel in order to generate a physical good or a portion thereof.

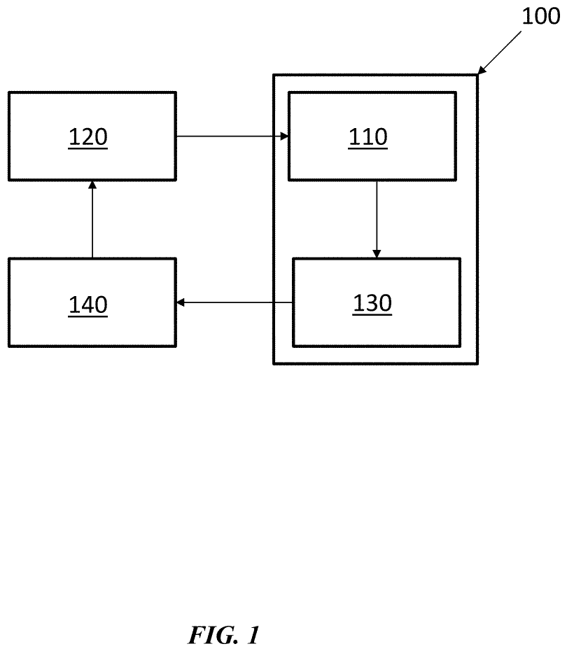

FIG. 1 illustrates an exemplary system 100 for analyzing runs. The system 100 may comprise a data processing module 110 configured to extract artifacts automatically from observed process data and/or metadata associated with an industrial process. The data processing module 110 may comprise a processor or a circuit. The observed process data and/or metadata may comprise, for example, Observation Data, Context Data, Metric Data, and/or OEE Data, each of which is described in greater detail below. In some cases, the observed process data may correspond to Observation Data, Metric Data, and/or OEE Data, and the metadata may correspond to Context Data. The observed process data and/or the metadata associated with the industrial process may be obtained using one or more sensors 120. The one or more sensors 120 may be operatively coupled to manufacturing equipment 140 and/or one or more machines used to perform or execute one or more steps of the run. The one or more sensors 120 may be used to monitor or quantify a performance of the manufacturing equipment 140 and/or the one or more machines used to perform or execute one or more steps of the run, in real time or after one or more steps of a run have been completed. In some cases, the observed process data and/or metadata associated with the industrial process may be obtained using a plurality of sensors comprising the one or more sensors 120. Alternatively, the observed process data and/or the metadata associated with the industrial process may be obtained from one or more data sources (e.g., hard drives or databases comprising data or information about a run, or electronic or physical logs detailing one or more steps or events of a run).

In some cases, the system 100 may comprise a run analyzer 120 operatively coupled to the data processing module 110. The run analyzer 120 may comprise a processor or a circuit configured to generate a summary representation of a run. In some cases, the run analyzer 120 may be operatively coupled to manufacturing equipment, sensors, and/or one or more machines 140 used to perform or execute one or more steps of the run. In some cases, the run analyzer 120 may be configured to control, adjust, modify, and/or refine one or more operational characteristics that may affect a performance or an operation of the manufacturing equipment 140 and/or the one or more machines 140 used to perform or execute one or more steps of the run.

In some cases, the systems and methods of the present disclosure may be implemented to analyze live and/or historical production data to identify the key process parameters that contributed to the most profitable manufacturing runs. In some cases, the systems and methods of the present disclosure may be used to generate guidance or recommendations for adjusting, modifying, updating, refining, or fine tuning controllable variables on a factory floor to improve line speed without sacrificing product quality. The systems and methods of the present disclosure may be implemented using factory data that may be obtained from machines, manufacturing equipment, and/or sensors operatively coupled to such machines or manufacturing equipment. In some cases, the systems and methods of the present disclosure may be used to create a digital thread of a production process. In such cases, factory or manufacturing data may be processed and contextualized into a consistent format, organized into a taxonomy that assigns semantics to the data, and aligned with metadata such as the product, shift or quality state. The digital thread may be configured to translate manufacturing expertise into an actionable, data-based representation of a production line to serve as a roadmap for predicting and optimizing manufacturing performance for a plurality of different manufacturing processes.

Artifacts

The systems and methods of the present disclosure may be implemented to infer one or more semantic artifacts associated with a run. As used herein, a semantic artifact may comprise a qualitative and/or quantitative attribute or metric associated with one or more steps, procedures, events, aspects, qualities, and/or features of an industrial process (e.g., a manufacturing or production run).

Each artifact may correspond to a contiguous interval in time and may be associated with (i) start and end timestamps, (ii) a semantically meaningful name, and in some cases, (iii) a descriptive category. Example of semantically meaningful names may include: “ramp up”, “stable periods”, “unstable periods”, “setpoint changes”, and “downtime”. Examples of descriptive categories for “downtime” may include: “maintenance”, “unplanned downtime”, and “out of material.” In some cases, the artifacts may not or need not correspond to a single contiguous interval in time. In some cases, the artifacts may correspond to a plurality of contiguous intervals in time that are temporally remote from each other.

The systems and methods of the present disclosure may be implemented to extract artifacts, including names and categories, automatically from observed process data and/or metadata associated with an industrial process. The observed process data and/or metadata may comprise, for example, information associated with one or more context intervals (e.g., material, product, shift, operator, batch, phase, state), temporal process data, and in some cases, OEE components (i.e., product quality, performance, availability). As used herein, OEE may refer to Overall Equipment Effectiveness, which may comprise a framework for measuring the efficiency and effectiveness of a process, by breaking it down into three constituent components (herein referred to as OEE components or factors). OEE can be used to measure manufacturing productivity by identifying the percentage of manufacturing time that is truly productive. An OEE score of 100% may indicate that a manufacturing process is outputting only Good Parts (i.e., parts that meet one or more pre-determined part quality standards), as fast as possible, with no Stop Time or Down time (i.e., all times during which a manufacturing process was intended to run, but was not due to unplanned stops such as breakdown or planned stops such as operator changeovers). In other words, an OEE score of 100% may indicate 100% Quality (only Good Parts), 100% Performance (as fast as possible), and 100% Availability (no Stop Time). OEE may be used to help manufacturers or operators to identify, measure, and fix problems associated with a manufacturing process, and can provide a standardized method of identifying losses, benchmarking progress, and improving the productivity of manufacturing equipment (e.g., by eliminating waste).

In some cases, the extracted artifacts and any vocabulary or data associated with the extracted artifacts may be used to build a summary representation of each run. The summary representation may comprise a summary of events, issues, inefficiencies, and/or performance characteristics associated with an industrial process or a manufacturing run. In some cases, the summary representation may be organized in a time-based manner that corresponds to a chronological progression of steps for a particular industrial process or manufacturing run. In some cases, the summary representation may be reorganized to display a customized set or subset of various events, issues, inefficiencies, and/or performance characteristics of interest. The summary representation may be manually customized by a user or automatically customized to match a user's historical preferences.

The systems and methods of the present disclosure may be implemented to provide numerous benefits from a manufacturing standpoint. For example, the systems and methods of the present disclosure may be used to reduce a need for operator input, thereby reducing an impact of input errors on operations and analysis and reducing a workload of operators who are monitoring or performing one or more steps of a manufacturing process. The systems and methods of the present disclosure may also be used to improve machine learning modeling results by converting manufacturing runs into semantically meaningful summaries and using such semantically meaningful summaries as inputs for further optimizations and/or additional predictions. In some cases, the systems and methods of the present disclosure may be implemented to enhance interpretability of manufacturing performance and discovery of manufacturing inefficiencies by providing operators or manufacturers with a qualitative or quantitative assessment of what happened during a manufacturing run. In some cases, the systems and methods of the present disclosure may be used to provide operators or manufacturers with a broad narrative about one or more product runs within a vertical of a product line, manufacturing line, or contextual event.

In some cases, the systems and methods of the present disclosure may be implemented to enable a digital twin like capability. A “digital twin” as referred to herein may comprise a replication of the form and function of a physical entity in a digital environment using data. Such replication may include or may be based on all information about a particular asset and its ability to interact with or respond to other assets. In manufacturing, assets may comprise the machines or equipment involved in production on the factory floor. The digital twin may make it possible to simulate, study, and predict scenarios that the physical asset may be subjected to. The digital twin may have many different applications in the manufacturing industry. One example would be study of the performance of a jet engine (the product) in turbulent conditions to set the metrics for optimal production. For process factories like food manufacturers, the digital twin can be used to replicate the entire plant and all of its processes. The digital twin may be created by gathering data from a real-world physical object or a system (e.g., a manufacturing system) using one or more sensors. The one or more sensors may comprise, for example, imaging devices, chemical detection sensors, vibration detecting sensors, electrical sensors, navigation sensors, pressure sensors, force sensors, thermal sensors, proximity sensors, combinations thereof, and/or the like. The data gathered using the one or more sensors may be used to create online or offline models or replicas of the real-world system. With the help of the virtual digital replica, a manufacturer or operator can vary input parameters or stimuli to predict, observe and learn from different scenarios in order to further optimize the physical object or system (or any methods or processes that can be implemented using the system).

In some cases, a digital thread may be used to create a functional digital twin that can simulate a product's journey through a manufacturing process. The digital thread may represent or contextualize the flow of data across the entire product lifecycle in a way that is trackable and that can be studied, analyzed, and/or interpreted at any given stage of the life of the product. The digital twin created using the digital thread may be configured to generate information about the product, the manufacturing process used to fabricate the product, the behavior of the product within a manufacturing process, and/or an interaction of the product with one or more machines or manufacturing equipment used to fabricate the product (or a portion thereof).

The systems and methods of the present disclosure may be implemented to automatically infer a semantically meaningful quantitative and/or qualitative summary of a run (herein referred to interchangeably as a “story of a run”) in terms of a sequence of semantic artifacts. Each of the semantic artifacts may be associated with a semantically meaningful name, a category that qualifies or describes the artifact, and/or one or more start timestamps and end timestamps. The semantic artifacts or any data, information, or inferences associated with the semantic artifacts may be derived from observed data (e.g., sensor or instrument data obtained during an observation or a monitoring of an industrial process such as a manufacturing process run), context associated with the observed data, and/or OEE components of the industrial process or manufacturing process run.

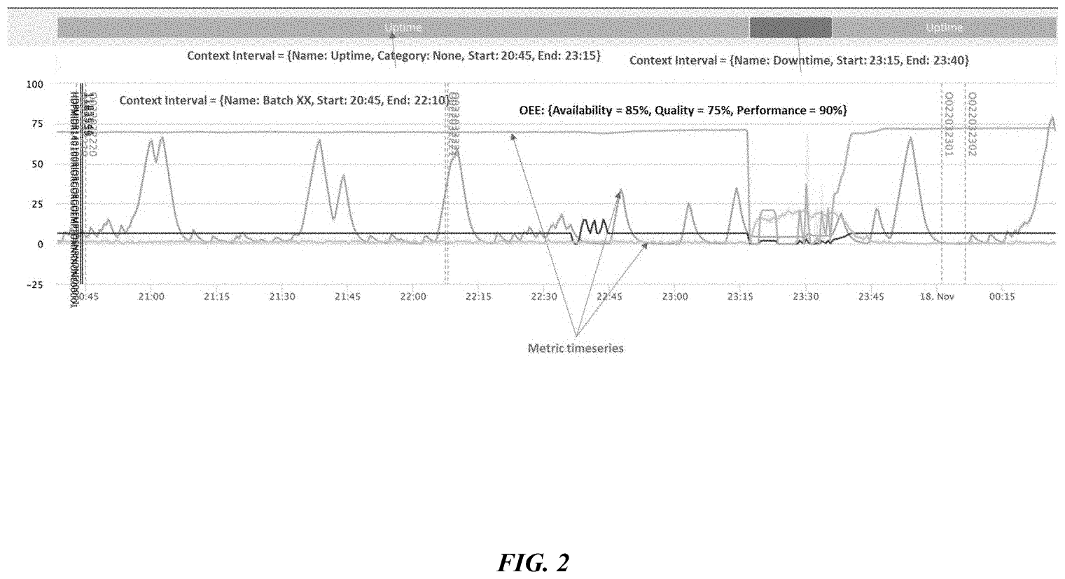

FIG. 2 schematically illustrates observed data, context intervals, and results for a given run. The one or more context intervals may be used to provide context about the execution of the process. The one or more context intervals may be used to indicate that a certain time period of the run is associated with a first characteristic (e.g., uptime). In some cases, the one or more context intervals may be used to indicate that a certain time period of the run is associated with a second characteristic (e.g., downtime). The temporal metric data may be used to describe attributes of the process as a numeric or data-based timeseries. The OEE components may be used to define the results or performance characteristics of the run.

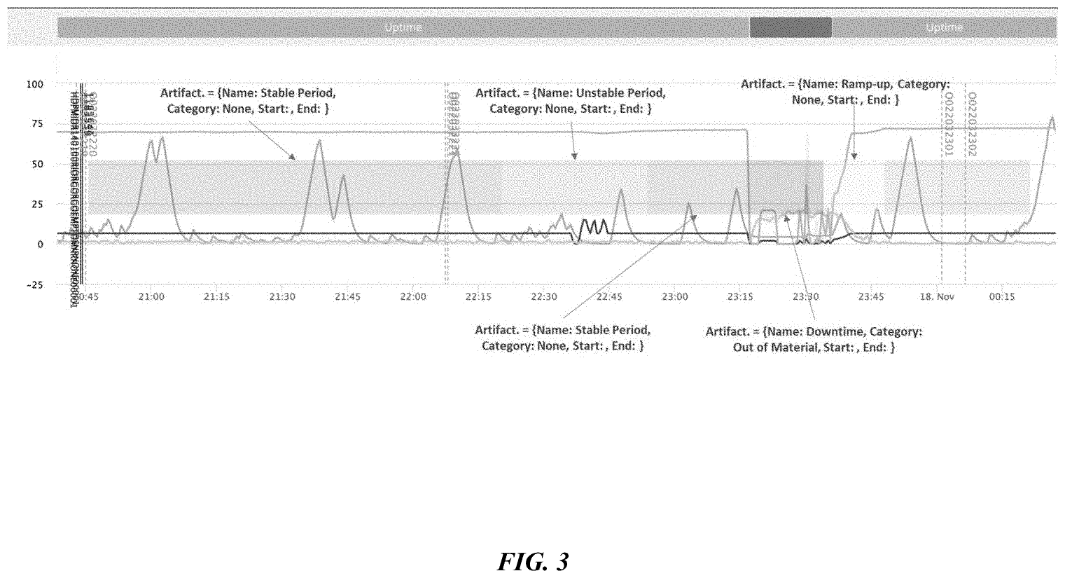

FIG. 3 schematically illustrates semantic artifacts that may be inferred from the run. The inferred semantic artifacts may comprise, for example, a ramp-up category, a stable periods category, an unstable periods category, and/or a downtime category. The automated inferences may be used to significantly reduce manual operator input, since the artifacts do not require explicit annotation by users. The automated inferences can also lead to a higher accuracy of annotated data that can be used for deeper analysis. In some cases, the automated inferences, the extracted individual artifacts, and/or a summary of a manufacturing run may be used as inputs into one or more machine learning and analysis models for the purpose of building predictive models or optimization of a manufacturing run. In other cases, the automated inferences may be used to improve interpretability of a manufacturing run through either manual analysis or visualization.

In another aspect, the present disclosure provides a method for analyzing a manufacturing run. The method may comprise defining one or more core semantic artifacts of a run that need to be identified. As described above, the one or more core semantic artifacts may comprise, for example, a ramp-up category, a stable periods category, an unstable periods category, and/or a downtime category. The one or more core semantic artifacts may be different for different process types. The method may further comprise developing a temporal and contextual feature representation of the manufacturing run. The method may further comprise training and developing models to extract individual semantic artifacts from the temporal and contextual feature representation of the manufacturing run. The method may further comprise extracting semantic artifacts using the trained models. The semantic artifacts may be extracted in real time to minimize operator input, and/or after a manufacturing run (or one or more steps of the manufacturing run) is performed or completed, to support post-run analysis of the manufacturing run. In some cases, the method may further comprise translating extracted semantic artifact sequences into a symbolic narrative for the manufacturing run that can be used for analysis and interpretation of the manufacturing run. The symbolic narratives generated using the systems and methods of the present disclosure may be used for further analysis of a manufacturing run to develop predictive models or optimization recommendations for one or more portions or aspects of the manufacturing run.

In some cases, the method may comprise defining artifacts of a run. In order to create a symbolic narrative for a given process domain, a set of semantically meaningful artifacts (e.g., artifact name and/or potential category) that need to be extracted from each run may be initially defined or identified. These artifacts may be pre-defined or pre-determined based on domain knowledge about the manufacturing process and/or the industry. In one example, the following artifacts may be considered, defined, and/or identified for an extrusion process: Ramp-up, Stable period, Unstable period, Downtime, and/or Ramp-down.

In some cases, the method may comprise collecting instances of each artifact from historical observations of the process. The historical observations may comprise sensor data obtained using one or more sensors that may be used to monitor a manufacturing run. Such instances may include the start and end timestamps, the name of the artifact, as well as a potential category for the artifact. This information can be used to extract the underlying process data as well as context intervals and any available OEE components (e.g., availability, quality, and/or performance, each of which may be represented as numerical values).

In some cases, the method may comprise building a feature representation of a run. Data and metadata associated with an individual manufacturing run (e.g., Observation Data, Context Data, Metric Data, and/or OEE Data) may be converted into a common feature representation. This feature representation may include the context of the run, the results of the run, as well as a temporal summary of the process and other data or metrics associated with the manufacturing run. Context may be represented as a set of context intervals, each of which may include a start timestamp, an end timestamp, and one or more qualitative or quantitative values associated with the context attribute (e.g. product, shift, operator, etc.). In some embodiments, only those context intervals that intersect in time with the start and end of an individual manufacturing or production run may be selected. In any of the embodiments described herein, the number of intervals may be different for different manufacturing processes.

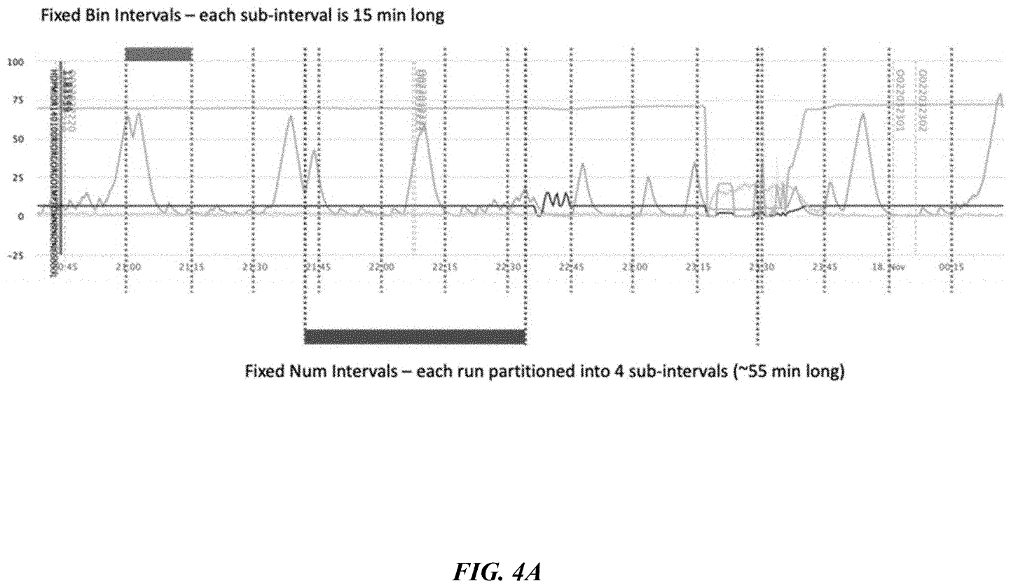

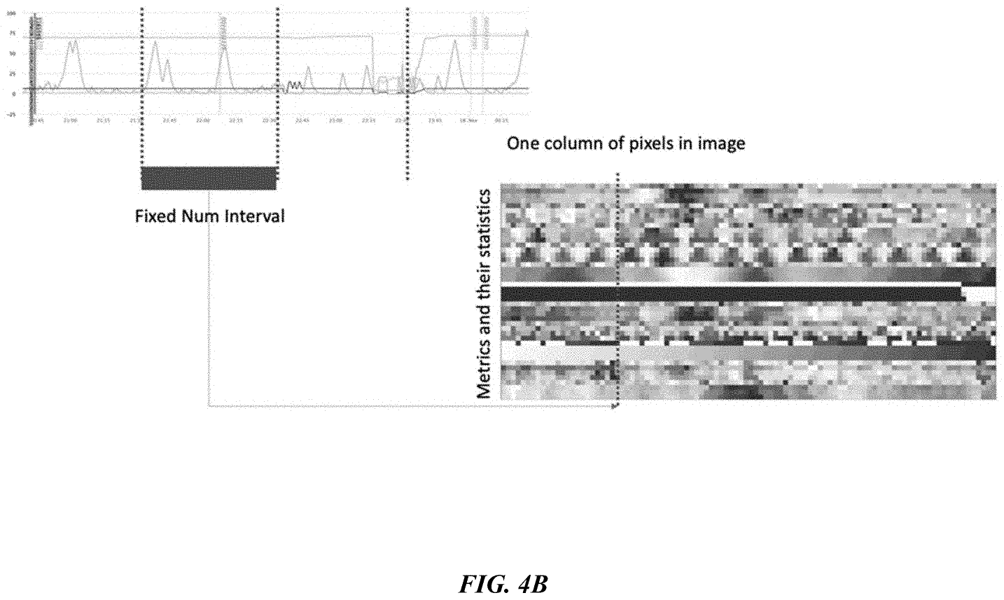

In some cases, the method may comprise extracting one or more temporal process metric summaries from the run, which one or more temporal process metric summaries may be based on or derived from the timeseries data associated with the run. The one or more temporal process metric summaries may comprise one or more process metrics that may be annotated with taxonomy labels that describe their roles within the manufacturing process. The taxonomy labels may comprise a label or an annotation that provides information about a quantitative and/or qualitative attribute associated with the one or more process metrics. In some cases, the taxonomy labels may be used to name, organize, and/or categorize the one or more process metrics into one or more non-exclusive categories that may be pre-defined for a manufacturing process (e.g., quality, performance, controllable, production, etc.). As shown in FIG. 4A, for each process metric timeseries associated with a manufacturing run, both a fixed-bin summary and a fixed-num summary may be generated. In any of the embodiments described herein, a manufacturing run may be partitioned into one or more fixed-bin summaries and/or one or more fixed-num summaries.

To create a fixed-bin summary, each run may be partitioned into equal sized sub-intervals whose size is provided as a resolution parameter (e.g. 5 minutes). The resolution parameter may be adjusted manually by an individual or automatically by a computer. For each sub-interval, statistical summaries of the timeseries may be generated, including (i) Moments: Mean, Standard Deviation, Skew, Kurtosis, (ii) Trends: Slope, Linear interpolation, (iii) Extrema: Max, Min, and/or (iv) targets. If a variable has targets, deviations from the target (measured as Cpl, Cpu and Cpk) may also be included. The number of such sub-intervals may depend on a length or a duration of the run.

To create fixed-num summaries, the run duration may be partitioned into a fixed number of sub-intervals of equal length (e.g. 100 sub-intervals), where each sub-interval duration depends on the length of the run (i.e., subintervals for different runs may have different durations). Just like with the fixed-bin representations described elsewhere herein, time-series summaries for each process metric (as moments, trends, extrema, and targets) may be computed.

In some cases, the fixed-num representation may be treated as an image with each sub-interval representing the columns of the image, and the process metric summaries representing the rows of the image. This may permit the use of one or more image analysis techniques to interpret and/or analyze this representation. As shown in FIG. 4B, the fixed-num representations may be converted into one or more images that may comprise information about metrics associated with a manufacturing run and statistics associated with such metrics.

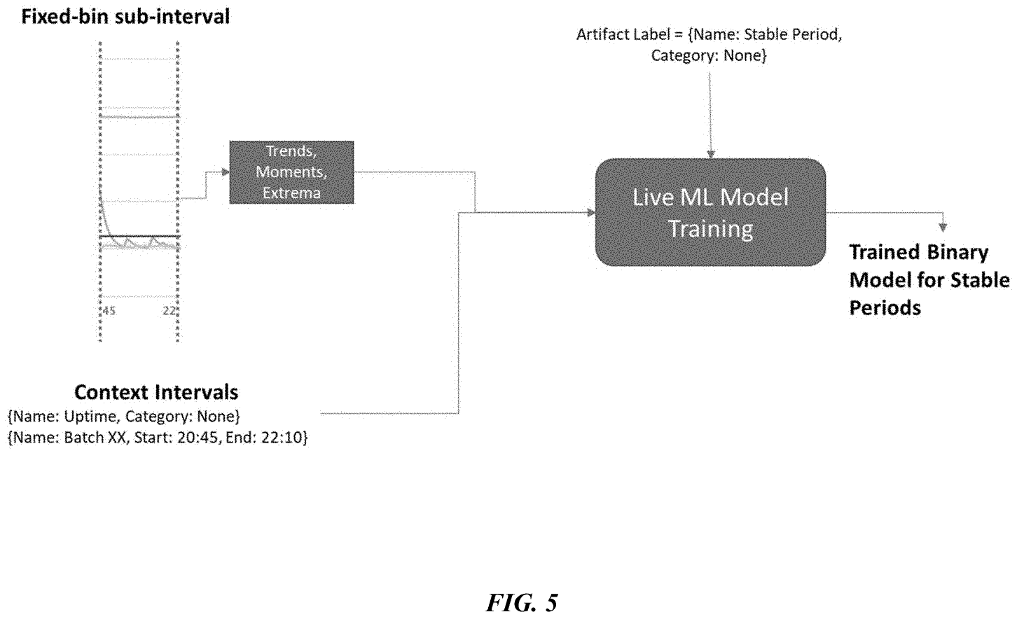

In some cases, a set of binary machine learning models may be used to extract the semantic artifacts that describe a manufacturing run from the feature representations developed. One or more semantic artifacts of interest may be labeled with a name and a category (which name and category may jointly constitute a label) based on one or more observed start and end timestamps in the run in the instances provided for model training. For example, one interval in the run may be labeled as “Ramp up” with a corresponding start timestamp and end timestamp. One or more models may then be trained for each type of artifact to identify the “Ramp up” artifact. The one or more models may comprise a first model that takes the fixed-bin summary and context intervals as inputs, and a second model that takes the fixed-num temporal summary along with context intervals and OEE components as inputs. In either case, each feature vector input to the model may comprise at least one sub-interval of either the fixed-bin or the fixed-num temporal summary, the value(s) of the context intervals that lie within the start and end of the sub-interval, and potentially the OEE components for the corresponding manufacturing run. An example of this for the fixed-bin representation is shown in FIG. 5, which schematically illustrates training an uptime model from the fixed-bin feature representation. Artifact-specific machine learning models may be trained to label each sub-interval, and the trained machine learning models may be applied to label each sub-interval live or offline. The corresponding outputs for the machine learning models may be obtained by propagating the training artifact label (and its associated category) to all sub-intervals that intersect with the labeled interval. Other sub-intervals in the run representation may be labeled accordingly (e.g., as “other”). One or more machine learning models may then be trained for each of the two different temporal summaries so that the one or more machine learning models learn to discriminate between these different classes labeled as “other”.

The systems and methods of the present disclosure may be implemented by training at least two different models. The first model may be trained on the fixed-bin summaries to infer artifacts in real-time, thereby reducing the need for manual operator input. The second model may be trained on fixed-num intervals and OEE components to improve the quality of the inference after the manufacturing run is completed. In order to train the machine learning models, a mixed initiative labeling approach may be leveraged. In such an approach, users may be permitted to label the artifact of interest in a small set of runs (i.e. their representations) and then retrieve similar sub-intervals from other runs based on the representation, for additional validation and labeling. This can reduce the amount of effort that needs to be invested in training the model. Additionally, this can mitigate the effect of a cold-start (i.e. when no data is labeled for a factory), since models trained on other data (e.g., either for the same customer or trained across other customers with the same or similar manufacturing process) can be used.

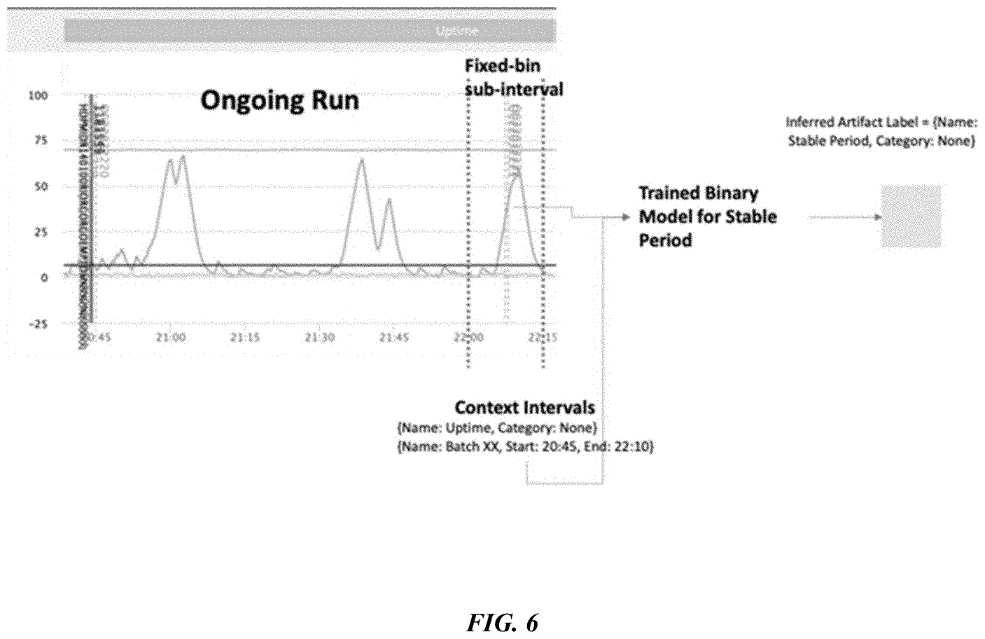

In some cases, the methods of the present disclosure may further comprise extracting semantic artifacts from runs. Artifacts may be extracted from runs by applying the trained machine learning models to the representations of the run. For live extraction, ML models trained on the fixed-bin summary with context variables may be used, since the length of the run is not known a priori, and neither are the OEE components. Live extraction of these semantic artifacts is important as it reduces the number or amount of input(s) that operators need to manually enter during the course of the run, thereby reducing their workload and minimizing or eliminating potential inaccuracies in the data. FIG. 6 schematically illustrates an exemplary process for inferring the artifact label using a live binary model.

After a run is complete, the artifact labeling can be further refined using the ML model trained on the fixed-num temporal summary along with the context variables and the OEE components. In order to do so, the artifact labels for each sub-interval can be re-inferred using the ML model. The re-inferred artifact labels can then be merged with the labels inferred using the ML model trained on the variable-width temporal representation, using an additional meta-model, or using one or more rules. Edge cases can also be dealt with when the sub-intervals of the variable-width representation do not line up with the sub-intervals of the fixed-width representation. In such cases, the inferred label can be taken as one that spans a majority of the duration of the sub-interval. In some cases, the inferred labels of the artifacts can be automatically updated, and one or more validations from a user may be taken into consideration during this update.

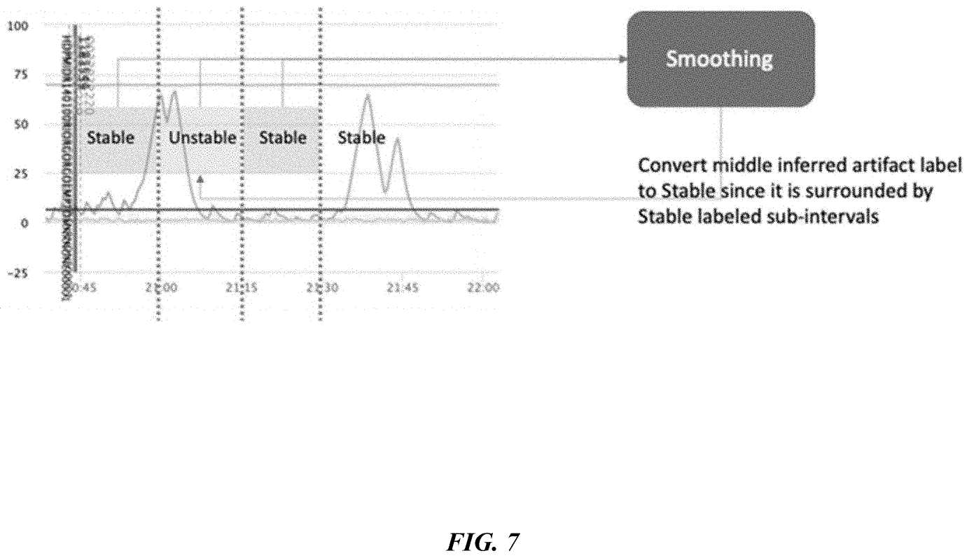

In some embodiments, temporal smoothing may be implemented for one or more inferred labels. FIG. 7 schematically illustrates temporal smoothing of an inferred artifact label. Since artifacts are temporally contiguous, a post-inference temporal smoothing may be applied. During this process, one or more rules may be used to retain temporal continuity in the inferred label. More specifically, if the two neighboring sub-intervals of a given sub-interval have the same label, then a label of the given sub-interval may be adjusted to also have the same label.

Once the semantic artifact labels for each sub-interval of the run are inferred, each run may be translated into a data series or a sequence of 4-tuples (e.g., Artifact Name, Artifact Category, Start timestamp, End timestamp). These 4-tuples may represent a symbolic narrative for the run. The symbolic narrative can be used as an input to additional ML models. In some cases, the symbolic narrative can be used to determine or identify what is different between one run versus other runs for a specific context (e.g. same product, or operator, or shift etc.). In some cases, the symbolic narrative can be used to determine or identify frequently occurring patterns in semantic artifacts that discriminate between “good” and “bad” runs, where good and bad may be defined in terms of the OEE components. In some alternative and non-limiting embodiments, each run may be translated into a data series or a sequence of 3-tuples (e.g., Semantic Artifact Label, Start timestamp, End timestamp). In such cases, the Semantic Artifact Label output may comprise a corresponding Artifact Name and Artifact Category.

In another aspect, the present disclosure provides a method for analyzing manufacturing runs. Such a method may be used to extract semantic artifacts, with an associated name, category, and start and end timestamps, from data and context available about a manufacturing run in order to minimize human operator input, improve the analysis and optimization of manufacturing processes, and enhance the interpretability of analysis results. The method may comprise taking as inputs (a) temporal metric data represented as numerical timeseries that measure the different chemical, mechanical, physical, and/or other properties of a manufacturing process, (b) context, represented as intervals with a start and end timestamp and (c) one or more values or metrics that describe the execution of the manufacturing process including operators, shifts, products, states, and optionally results such as OEE components (quality, performance, availability) associated with the run. In some cases, the method may further comprise building a feature representation of the run, wherein the feature representation comprises the context intervals, the start and end timestamps of the run, a fixed-bin temporal summary of the process metrics, a fixed-num temporal summary of the process metrics, and optionally the OEE components associated with the run. The fixed-bin feature representation of the run may be created by partitioning the duration of the run into fixed-width sub-intervals controlled by a resolution parameter. In some cases, moments, trends, and extrema of all metric data may be computed for each sub-interval. The fixed-num representation of the run may be created by partitioning each run into a fixed number of equal width sub-intervals, where the width may be determined as the duration of the run divided by the number parameter. In some cases, moments, trends, and extrema of the metric data may be computed for each sub-interval.

In some cases, the method may further comprise training a binary ML model (in some cases referred to as or called a Live Model or an Online Model) per type of semantic artifact and its category to classify feature vectors, each one extracted from one sub-interval of the fixed-bin temporal summary and the context intervals for the run, into one of two classes—either with the name and category of the semantic artifact or an “other” class.

In some cases, the method may further comprise training an Offline ML model per type of semantic artifact and category to classify feature vectors, each one extracted from one sub-interval of the fixed-num temporal summary, the context intervals, and the OEE components for the run, into one of two classes—either with the name and category of the semantic artifact, or an “other” class.

In some cases, the method may further comprise applying the trained Live Model for each artifact and category in real-time to infer the artifacts and their categories for fixed-bin sub-intervals of ongoing runs. In some case, the method may further comprise applying the trained Offline model for each artifact and category after the run is complete in order to infer the artifacts and their categories for the fixed-num sub-intervals. In some case, the method may further comprise applying a set of temporal smoothing rules on the output of either model to ensure that inferred artifacts are contiguous in time. In any of the embodiments described herein, the fixed-num feature summary may be converted into an image, and one or more image analysis techniques may be used to extract one or more artifacts from the image.

Computer Systems

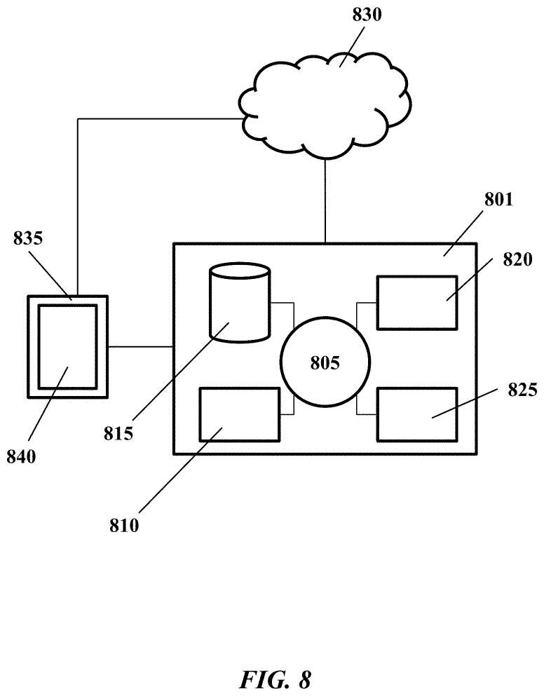

In an aspect, the present disclosure provides computer systems that are programmed or otherwise configured to implement methods of the disclosure, e.g., any of the subject methods for analyzing a manufacturing run. FIG. 8 shows a computer system 801 that is programmed or otherwise configured to implement a method for analyzing a manufacturing run. The computer system 801 may be configured to, for example, (a) receive and/or process manufacturing data corresponding to a manufacturing process, wherein the manufacturing data comprises at least one of observation data, context data, temporal metric data, and/or overall equipment effectiveness (OEE) components associated with the manufacturing process; (b) extract one or more semantic artifacts from the manufacturing data; and (c) use the one or more semantic artifacts to generate a summary representation of the manufacturing process. The computer system 801 can be an electronic device of a user or a computer system that is remotely located with respect to the electronic device. The electronic device can be a mobile electronic device.

The computer system 801 may include a central processing unit (CPU, also “processor” and “computer processor” herein) 805, which can be a single core or multi core processor, or a plurality of processors for parallel processing. The computer system 801 also includes memory or memory location 810 (e.g., random-access memory, read-only memory, flash memory), electronic storage unit 815 (e.g., hard disk), communication interface 820 (e.g., network adapter) for communicating with one or more other systems, and peripheral devices 825, such as cache, other memory, data storage and/or electronic display adapters. The memory 810, storage unit 815, interface 820 and peripheral devices 825 are in communication with the CPU 805 through a communication bus (solid lines), such as a motherboard. The storage unit 815 can be a data storage unit (or data repository) for storing data. The computer system 801 can be operatively coupled to a computer network (“network”) 830 with the aid of the communication interface 820. The network 830 can be the Internet, an internet and/or extranet, or an intranet and/or extranet that is in communication with the Internet. The network 830 in some cases is a telecommunication and/or data network. The network 830 can include one or more computer servers, which can enable distributed computing, such as cloud computing. The network 830, in some cases with the aid of the computer system 801, can implement a peer-to-peer network, which may enable devices coupled to the computer system 801 to behave as a client or a server.

The CPU 805 can execute a sequence of machine-readable instructions, which can be embodied in a program or software. The instructions may be stored in a memory location, such as the memory 810. The instructions can be directed to the CPU 805, which can subsequently program or otherwise configure the CPU 805 to implement methods of the present disclosure. Examples of operations performed by the CPU 805 can include fetch, decode, execute, and writeback.

The CPU 805 can be part of a circuit, such as an integrated circuit. One or more other components of the system 801 can be included in the circuit. In some cases, the circuit is an application specific integrated circuit (ASIC).

The storage unit 815 can store files, such as drivers, libraries and saved programs. The storage unit 815 can store user data, e.g., user preferences and user programs. The computer system 801 in some cases can include one or more additional data storage units that are located external to the computer system 801 (e.g., on a remote server that is in communication with the computer system 801 through an intranet or the Internet).

The computer system 801 can communicate with one or more remote computer systems through the network 830. For instance, the computer system 801 can communicate with a remote computer system of a user (e.g., a human operator, a manufacturing engineer, a manufacturing technician, a quality assurance specialist, a manufacturer, an employee of a manufacturing company, etc.). Examples of remote computer systems include personal computers (e.g., portable PC), slate or tablet PC's (e.g., Apple® iPad, Samsung® Gala8 Tab), telephones, Smart phones (e.g., Apple® iPhone, Android-enabled device, Blackberry®), or personal digital assistants. The user can access the computer system 801 via the network 830.

Methods as described herein can be implemented by way of machine (e.g., computer processor) executable code stored on an electronic storage location of the computer system 801, such as, for example, on the memory 810 or electronic storage unit 815. The machine executable or machine readable code can be provided in the form of software. During use, the code can be executed by the processor 805. In some cases, the code can be retrieved from the storage unit 815 and stored on the memory 810 for ready access by the processor 805. In some situations, the electronic storage unit 815 can be precluded, and machine-executable instructions are stored on memory 810.

The code can be pre-compiled and configured for use with a machine having a processor adapted to execute the code, or can be compiled during runtime. The code can be supplied in a programming language that can be selected to enable the code to execute in a pre-compiled or as-compiled fashion.

Aspects of the systems and methods provided herein, such as the computer system 801, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media including, for example, optical or magnetic disks, or any storage devices in any computer(s) or the like, may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 801 can include or be in communication with an electronic display 835 that comprises a user interface (UI) 840 for providing, for example, a portal for a user to view one or more summary representations of a manufacturing run. The portal may be provided through an application programming interface (API). A user or entity can also interact with various elements in the portal via the UI. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 805. For example, the algorithm may be configured to (a) receive and/or process manufacturing data corresponding to a manufacturing process, wherein the manufacturing data comprises at least one of observation data, context data, temporal metric data, and/or overall equipment effectiveness (OEE) components associated with the manufacturing process; (b) extract one or more semantic artifacts from the manufacturing data; and (c) use the one or more semantic artifacts to generate a summary representation of the manufacturing process.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

What is claimed is:

1. A method for extracting semantic artifacts from manufacturing data, comprising:
(a) receiving manufacturing data corresponding to a manufacturing process, wherein the manufacturing data comprises at least one of observation data, context data, temporal metric data, and/or overall equipment effectiveness (OEE) components associated with the manufacturing process;
(b) extracting one or more semantic artifacts from the manufacturing data; and
(c) using the one or more semantic artifacts to generate a summary representation of the manufacturing process.

2. The method of claim 1, wherein the observation data comprises data about the manufacturing process that is obtained using one or more sensors or from one or more data sources.

3. The method of claim 1, wherein the context data comprises (i) data represented as intervals with a start timestamp and an end timestamp and (ii) a value describing an aspect of an execution of the manufacturing process, wherein said value is associated with one or more operators, shifts, materials, products, batches, phases, and/or states relating to the manufacturing process.

4. The method of claim 1, wherein the context data comprises data corresponding to one or more time intervals, wherein the data comprises one or more values quantifying or representing a characteristic, quality, parameter, or property of (i) the manufacturing process or an execution thereof or (ii) an output of the manufacturing process.

5. The method of claim 1, wherein the temporal metric data comprises data represented as a numerical timeseries that measures one or more mechanical, physical, chemical, or operational properties of the manufacturing process.

6. The method of claim 1, wherein the OEE components comprise data about a product quality, a manufacturing performance, and/or a manufacturing availability associated with an operation or an execution of one or more steps of the manufacturing process.

7. The method of claim 1, wherein the one or more semantic artifacts correspond to a ramp-up, a stable period, an unstable period, and/or a downtime associated with the manufacturing process.

8. The method of claim 7, wherein the one or more semantic artifacts comprise a name, a category, and one or more start timestamps or end timestamps.

9. The method of claim 1, wherein the summary representation of the manufacturing process comprises a feature representation comprising the context data, one or more start timestamps and/or one or more end timestamps associated with the manufacturing process, a fixed-bin temporal summary of one or more process metrics, a fixed-num temporal summary of the one or more process metrics, and optionally the one or more OEE components associated with the manufacturing process.

10. The method of claim 9, further comprising generating the fixed-bin feature representation by partitioning a duration of the manufacturing process into one or more fixed-width sub-intervals controlled by a resolution parameter, and computing moments, trends, and extrema of the metric data for each sub-interval.

11. The method of claim 9, further comprising generating the fixed-num representation by partitioning the manufacturing process into a fixed number of equal width sub-intervals, wherein the width is determined by dividing a time duration of the manufacturing process by a number parameter, and computing moments, trends, and extrema of the metric data for each sub-interval.

12. The method of claim 11, further comprising converting the fixed-num feature summary into an image and applying one or more image analysis techniques to extract the one or more semantic artifacts or any metadata associated with the one or more semantic artifacts.

13. The method of claim 1, further comprising:
training a live machine learning model for each type of semantic artifact and a category associated with the semantic artifact to classify one or more feature vectors, which feature vectors are extracted from at least one sub-interval of a fixed-bin temporal summary associated with the manufacturing process and one or more context intervals for the manufacturing process.

14. The method of claim 1, further comprising:
training an offline machine learning model for each type of semantic artifact and a category associated with the semantic artifact to classify one or more feature vectors, which feature vectors are extracted from at least one sub-interval of a fixed-num temporal summary associated with the manufacturing process, one or more context intervals for the manufacturing process, and the one or more OEE components for the manufacturing process.

15. The method of claim 13, further comprising:
applying the trained live model for each artifact and category in real-time to infer the one or more artifacts and their categories for one or more fixed-bin sub-intervals of an ongoing run.

16. The method of claim 14, further comprising:
applying the trained offline model for each artifact and category after a run is completed to infer the one or more artifacts and their categories for one or more fixed-num sub-intervals of the completed run.

17. The method of claim 15, further comprising:
applying temporal smoothing to one or more outputs of the trained models such that the one or more inferred artifacts are contiguous in time.

18. The method of claim 17, further comprising using the one or more inferred artifacts to construct or update the summary representation of the manufacturing process.
